(19) United States
(12) Patent Application Publication
(10) Pub. No.: US 2004/0019474 A1
(43) Pub. Date: Jan. 29, 2004

(54) Method and apparatus to facilitate detecting a slow node in a circuit layout

(76) Inventors: Ghun Kim, Sunnyvale, CA (US); Seong Rai Cho, San Jose, CA (US); Daesuk Jung, Santa Clara, CA (US); Yet-Ping Pai, Milpitas, CA (US)

Correspondence Address: PARK, VAUGHAN & FLEMING LLP, 508 SECOND STREET, SUITE 201, DAVIS, CA, 95616, US

(21) Appl. No.: 10/207,699

(22) Filed: Jul. 29, 2002

(51) Int. Cl. G06F 17/50

(52) U.S. Cl. 703/19

(57) ABSTRACT

One embodiment of the present invention provides a system that facilitates detecting one or more slow nodes in an integrated circuit layout. During operation, the system receives an integrated circuit layout. Next, the system inserts repeaters into signal lines of the integrated circuit layout to define a set of nets. The system then produces a resistance/capacitance (R/C) model for each net and obtains a timing model for each driver and receiver in the integrated circuit layout. This timing model specifies a non-linear circuit model for each driver and a non-linear circuit model for each receiver in the layout. The system then performs a circuit simulation using the timing model for each driver and receiver and the R/C model for each net. The system uses results of this circuit simulation to identify one or more slow nodes in the integrated circuit layout.

### BACKGROUND

1. Field of the Invention

The present invention relates to the process of designing and verifying a circuit. More specifically, the present invention relates to a method and an apparatus to facilitate detecting a slow node in a circuit layout.

2. Related Art

Modern computer systems are continually being enhanced to increase their capability and speed. These enhancements are typically the result of innovations such as faster clock speeds, reduced voltages, and smaller components within the integrated circuits that comprise the computer systems.

As components within the integrated circuits get smaller and clock speeds get faster, it is becoming increasingly more important to minimize propagation delay through signal lines on the integrated circuit. To this end, it is common practice to insert repeaters into signal lines within an integrated circuit to provide adequate signal strength to drive distant receivers located across the integrated circuit. Moreover, many signal lines, such as clock signal lines, require repeaters to provide adequate signal strength to drive multiple loads located at the ends of branches on the signal line.

Note that inherent resistance and capacitance on these signal lines affects the propagation of signals between drivers and receivers on the signal lines. An undersized driver may not be able to provide sufficient current to rapidly charge the signal lines. Providing insufficient drive current can cause a slow rise time at a terminal node on a signal line, making the signal received at the terminal node more susceptible to impressed noise. Nodes with slow signal rise times are typically referred to as “slow nodes.”

Designers typically analyze timing on signal lines within an integrated circuit using static timing analysis. While static timing analysis provides a somewhat accurate measure of propagation delay through a circuit, there are a number of shortcomings to this technique. Static timing analysis typically only accounts for propagation delays. While it is useful to know expected propagation delays through a system, the delay values by themselves give no indication of how susceptible signal lines are to noise. For example, a signal line with a slow node is more susceptible to noise than a signal with the same propagation delay that does not have a slow node. Moreover, existing models used for static timing analysis typically use a simplified linear driver model, which does not account for significant non-linearities in driver characteristics that can have a significant effect on system performance.

Hence, what is needed is a method and an apparatus that facilitates detecting slow nodes within an integrated circuit layout. Additionally, what is needed is a timing analysis tool that accounts for non-linearities in driver performance.

### SUMMARY

One embodiment of the present invention provides a system that facilitates detecting one or more slow nodes in an integrated circuit layout. During operation, the system receives an integrated circuit layout. Next, the system inserts repeaters into signal lines of the integrated circuit layout to define a set of nets. The system then produces a resistance/capacitance (R/C) model for each net and obtains a timing model for each driver and receiver in the integrated circuit layout. This timing model specifies a non-linear circuit model for each driver and a non-linear circuit model for each receiver in the layout. The system then performs a circuit simulation using the timing model for each driver and receiver and the R/C model for each net. The system uses results of this circuit simulation to identify one or more slow nodes in the integrated circuit layout.

In one embodiment of the present invention, producing the R/C model for each net involves dividing each net into one or more nodes, wherein each node is modeled with a single resistance element and a single capacitance element.

In one embodiment of the present invention, obtaining the timing model for each driver and receiver involves selecting a substantially equivalent driver/receiver model for each driver/receiver from a set of pre-defined driver/receiver models, replacing the timing model for each driver and receiver with the non-linear circuit model and adding resistance and capacitance to each driver and receiver model if necessary.

In one embodiment of the present invention, selecting the substantially equivalent driver/receiver model involves considering a driver resistance and/or a receiver capacitance.

In one embodiment of the present invention, the system uses a SPICE analysis to perform the circuit simulation.

In one embodiment of the present invention, the system speeds a slow node by moving a repeater associated with the slow node.

In one embodiment of the present invention, the system speeds a slow node by moving the slow node to a different layer of the integrated circuit layout.

In one embodiment of the present invention, the system speeds a slow node by inserting additional repeaters in an associated network.

In one embodiment of the present invention, locating a slow node involves comparing the timing for each potential slow node with an allowed propagation time.

### BRIEF DESCRIPTION OF THE FIGURES

FIG. 1 illustrates a computer 102 in accordance with an embodiment of the present invention.

FIG. 2A illustrates a driver coupled to a receiver in accordance with an embodiment of the present invention.

FIG. 2B illustrates a circuit network with lumped parameters in accordance with an embodiment of the present invention.

FIG. 3 illustrates signal distribution in accordance with an embodiment of the present invention.

FIG. 4A illustrates normal node timing in accordance with an embodiment of the present invention.

FIG. 4B illustrates slow node timing in accordance with an embodiment of the present invention.

FIG. 5 is a flowchart illustrating the process of identifying slow nodes in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

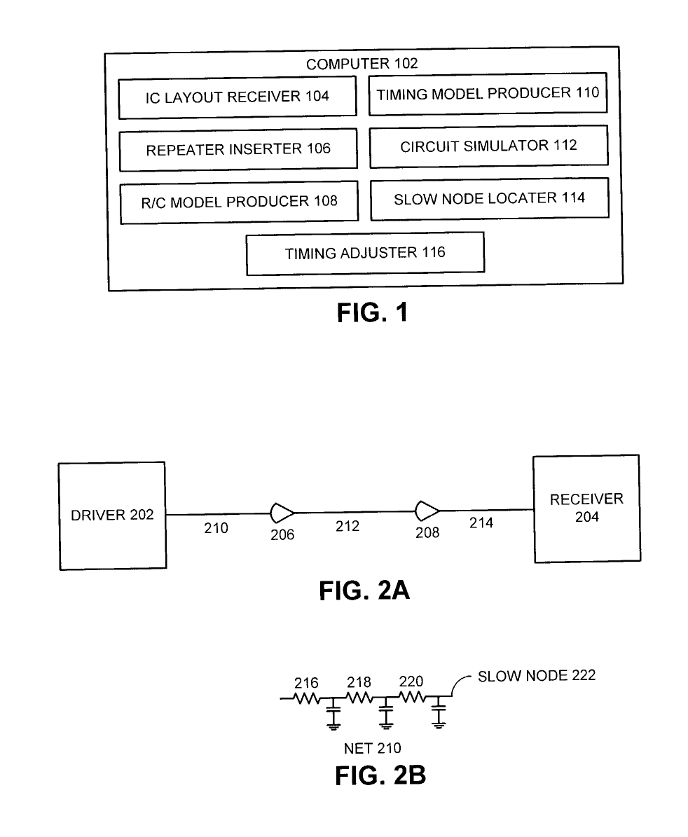

FIG. 1 illustrates a computer 102 in accordance with an embodiment of the present invention. Computer 102 includes IC layout receiver 104, repeater inserter 106, resistance/capacitance (R/C) model producer 108, timing model producer 110, circuit simulator 112, slow node locater 114, and timing adjuster 116.

IC layout receiver 104 receives integrated circuit layouts, typically after a place and route operation. At this point repeater inserter 106 inserts repeaters into the signal lines of the integrated circuit layout to define a set of nets. Note that repeater inserter 106 can also insert repeaters to correct a slow node as described below.

R/C model producer 108 produces R/C models for each net within the set of nets. Timing model producer 110 obtains a timing model for each driver and receiver within the integrated circuit layout. These timing models specify a non-linear circuit model for each driver and a non-linear circuit model for each receiver. During this process, timing model producer 110 locates substantially equivalent driver/receiver models for each driver/receiver from a set of pre-defined driver/receiver models (not shown). Additionally, timing model producer 110 adds excess resistance and capacitance to each driver model and receiver model if necessary.

Circuit simulator 112 then performs an analysis using the timing models and the R/C models. For example, this analysis can be a SPICE simulation of the integrated circuit. Slow node locater 114 examines the output of circuit simulator 112 to locate any slow nodes. A slow node is any node that has a timing greater than a predefined threshold value. Timing adjuster 116 then corrects the timing at the slow nodes, for example by moving a repeater, moving the network associated with the slow node to a different layer of the integrated circuit, or by inserting additional repeaters into the network.

Nodes and Networks

FIG. 2A illustrates a driver coupled to a receiver in accordance with an embodiment of the present invention. Driver 202 is coupled to receiver 204 through a combination of nets and repeaters. Specifically, the combination includes nets 210, 212, and 214 and repeaters 206 and 208. Signals propagating from driver 202 to receiver 204 pass successively across net 210, repeater 206, net 212, repeater 208, and net 214 to reach receiver 204. Note that each of these nets can include a slow node.

FIG. 2B illustrates a circuit network with lumped parameters in accordance with an embodiment of the present invention. Net 210 is typical of networks within the integrated circuit layout. For modeling purposes, net 210 is divided into nodes 216, 218, and 220. Each of these nodes is represented by a resistance and a capacitance. Note that there can be more or fewer nodes than shown for each net within the integrated circuit layout. The final node is potentially a slow node, for example slow node 222.

Signal Distribution

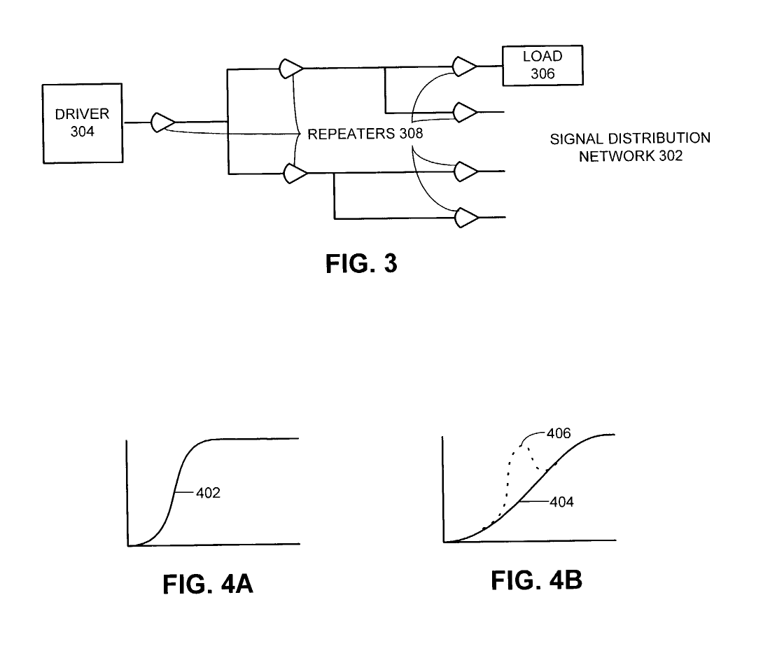

FIG. 3 illustrates a signal distribution network in accordance with an embodiment of the present invention. Signal distribution network 302 is a typical signal distribution tree, such as a clock distribution tree for an integrated circuit. FIG. 3 illustrates driver 304, load 306, and repeaters 308. Note that each leg of the clock distribution tree is terminated in a load similar to load 306. Moreover, there can be a slow node at the input to each repeater and each load.

Node Timing

FIG. 4A illustrates transition timing for a normal node in accordance with an embodiment of the present invention. Note that signal edge 402 rises sharply to a high voltage level from a low voltage level. The transition time from the low level to the high level is short, leaving little opportunity for interference from noise signals imposed on the transition.

FIG. 4B illustrates transition timing for a slow node in accordance with an embodiment of the present invention. As shown, signal edge 404 has a long rise time during the transition from the low voltage level to the high voltage level. This slow transition can allow a noise pulse, such as noise pulse 406, to greatly affect the timing of the change of state at a receiver associated with signal edge 404.

Identifying Slow Nodes

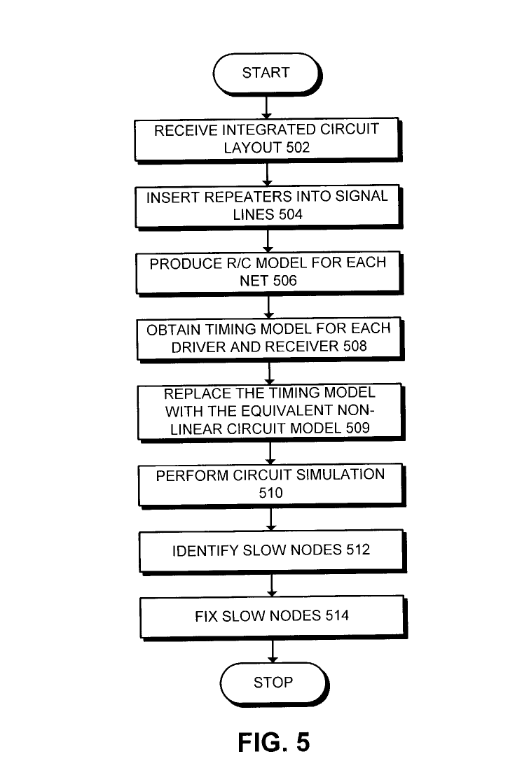

FIG. 5 is a flowchart illustrating the process of identifying slow nodes in accordance with an embodiment of the present invention. The system starts when IC layout receiver 104 receives an integrated circuit layout (step 502). Next, repeater inserter 106 inserts repeaters into the signal lines within the IC layout (step 504).

After the repeaters have been inserted into the signal lines, R/C model producer 108 produces an R/C model for each net (step 506). Next, timing model producer 110 obtains a timing model for each driver and receiver from a set of predefined models of drivers and receivers (step 508). The timing model specifies a non-linear resistance for each driver and a non-linear capacitance for each receiver. If needed, timing model producer 110 adds resistance and capacitance to a given driver model and given receiver model.

As an example, if the R/C model produced by R/C model producer 108 specifies a 150-ohm resistance and a 10-femtofarad capacitance, timing model producer 110 might select a driver with 100 ohms of resistance and a receiver with 7 femtofarads of capacitance. Timing model producer 110 replaces the driver and receiver models with the non-linear circuit models (step 509). Timing model producer 110 would then add 50 ohms of resistance and 3 femtofarads of capacitance to the model.

After the timing model has been adjusted to the correct non-linear circuit model, circuit simulator 112 performs a circuit simulation using the R/C models and the timing models (step 510). This circuit simulation typically involves performing a SPICE simulation. Next, slow node locater 114 examines the results of the circuit simulation to identify any slow nodes (step 512). Finally, timing adjuster 116 corrects the timing for the slow nodes, for example by moving the repeaters, moving the circuit net to a different layer of the integrated circuit, adding more repeaters, or a combination of these operations (step 514).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for detecting one or more slow nodes in an integrated circuit layout, comprising:
receiving the integrated circuit layout;
inserting repeaters into signal lines of the integrated circuit layout to define a set of nets;
producing an R/C model for each net;
obtaining a timing model for each driver and receiver in the integrated circuit layout, wherein the timing model specifies a non-linear circuit model for each driver and a non-linear circuit model for each receiver;
performing a circuit simulation using the timing model for each driver and receiver and the R/C model for each net; and
using a result of the circuit simulation to identify one or more slow nodes in the integrated circuit layout.

2. The method of claim 1, wherein producing the R/C model for each net involves dividing each net into one or more nodes, wherein each node is modeled with a single resistance element and a single capacitance element.

3. The method of claim 1, wherein obtaining the timing model for each driver and receiver involves:
identifying a substantially equivalent driver/receiver model for each driver/receiver from a set of pre-defined driver/receiver models; and
adding resistance and capacitance to each driver model and each receiver model if necessary.

4. The method of claim 3, wherein identifying the substantially equivalent driver/receiver model involves considering a driver resistance and/or a receiver capacitance.

5. The method of claim 3, further comprising using a SPICE analysis in performing the circuit simulation.

6. The method of claim 1, further comprising speeding a slow node by moving a repeater associated with the slow node.

7. The method of claim 1, further comprising speeding a slow node by moving the slow node to a different layer of the integrated circuit layout.

8. The method of claim 1, further comprising speeding a slow node by inserting additional repeaters in an associated network.

9. The method of claim 1, wherein locating a slow node involves comparing a timing for a node with an allowed propagation time.

10. A computer-readable storage medium storing instructions that when executed by a computer cause the computer to perform a method for detecting one or more slow nodes in an integrated circuit layout, the method comprising:
receiving the integrated circuit layout;
inserting repeaters into signal lines of the integrated circuit layout to define a set of nets;
producing an R/C model for each net;
obtaining a timing model for each driver and receiver in the integrated circuit layout, wherein the timing model specifies a non-linear circuit model for each driver and a non-linear circuit model for each receiver;
performing a circuit simulation using the timing model for each driver and receiver and the R/C model for each net; and
using a result of the circuit simulation to identify one or more slow nodes in the integrated circuit layout.

11. The computer-readable storage medium of claim 10, wherein producing the R/C model for each net involves dividing each net into one or more nodes, wherein each node is modeled with a single resistance element and a single capacitance element.

12. The computer-readable storage medium of claim 10, wherein obtaining the timing model for each driver and receiver involves:
identifying a substantially equivalent driver/receiver model for each driver/receiver from a set of pre-defined driver/receiver models;
replacing the timing model with the non-linear circuit model; and
adding resistance and capacitance to each driver model and each receiver model if necessary.

13. The computer-readable storage medium of claim 12, wherein identifying the substantially equivalent driver/receiver model involves considering a driver resistance and/or a receiver capacitance.

14. The computer-readable storage medium of claim 12, the method further comprising using a SPICE analysis in performing the circuit simulation.

15. The computer-readable storage medium of claim 10, the method further comprising speeding a slow node by moving a repeater associated with the slow node.

16. The computer-readable storage medium of claim 10, the method further comprising speeding a slow node by moving the slow node to a different layer of the integrated circuit layout.

17. The computer-readable storage medium of claim 10, the method further comprising speeding a slow node by inserting additional repeaters in an associated network.

18. The computer-readable storage medium of claim 10, wherein locating a slow node involves comparing a timing for a node with an allowed propagation time.

19. An apparatus for detecting one or more slow nodes in an integrated circuit layout, comprising:
a receiving mechanism that is configured to receive the integrated circuit layout;
an inserting mechanism that is configured to insert repeaters into signal lines of the integrated circuit layout to define a set of nets;
a model producing mechanism that is configured to produce an R/C model for each net;
a timing model obtaining mechanism that is configured to obtain a timing model for each driver and receiver in the integrated circuit layout, wherein the timing model specifies a non-linear circuit model for each driver and a non-linear circuit model for each receiver;
a simulation performing mechanism that is configured to perform a circuit simulation using the timing model for each driver and receiver and the R/C model for each net; and
an identifying mechanism that is configured to identify one or more slow nodes in the integrated circuit layout using a result of the circuit simulation.

20. The apparatus of claim 19, wherein producing the R/C model for each net involves dividing each net into one or more nodes, wherein each node is modeled with a single resistance element and a single capacitance element.

21. The apparatus of claim 19, further comprising:
identifying mechanism that is configured to identify a substantially equivalent driver/receiver model for each driver/receiver from a set of pre-defined driver/receiver models; and
an adding mechanism that is configured to add resistance and capacitance to each driver model if necessary.

22. The apparatus of claim 21, wherein identifying the substantially equivalent driver/receiver model involves considering a driver resistance and/or a receiver capacitance.

23. The apparatus of claim 21, further comprising an analyzing mechanism that is configured to use a SPICE analysis in performing the circuit simulation.

24. The apparatus of claim 19, further comprising a speedup mechanism that is configured to speed a slow node by moving a repeater associated with the slow node.

25. The apparatus of claim 19, further comprising a speedup mechanism that is configured to speed a slow node by moving the slow node to a different layer of the integrated circuit layout.

26. The apparatus of claim 19, further comprising a speedup mechanism that is configured to speed a slow node by inserting additional repeaters in an associated network.

27. The apparatus of claim 19, wherein locating a slow node involves comparing a timing for a node with an allowed propagation time.
